(19) United States
(12) Patent Application Publication
(10) Pub. No.: US 2007/0148363 A1
(43) Pub. Date: Jun. 28, 2007

(54) Method for manufacturing a photocatalytically active layer

(75) Inventors: Peter Heinrich, Germering (DE); Heinrich Kreye, Hamburg (DE); Tobias Schmidt, Eslohe (DE); Frank Gaertner, Hamburg (DE)

Correspondence Address: CROWELL & MORING LLP;INTELLECTUAL PROPERTY GROUP, P.O. BOX 14300, WASHINGTON, DC, 20044-4300, US

(73) Assignee: Linde Aktiengesellschaft, Wiesbaden (DE)

(21) Appl. No.: 11/595,368

(22) Filed: Nov. 8, 2006

(30) Foreign Application Priority Data
Nov. 8, 2005 (DE) 10 2005 053 263.2

(51) Int. Cl. B05D 1/02; B05D 1/36

(52) U.S. Cl. 427/427; 427/202

(57) ABSTRACT

A process for manufacturing metallic objects such as films, sheet metal or moldings, with a photocatalytically active surface through the application or introduction of photocatalytically active material by means of cold-gas spraying technology is disclosed. To increase the durability of the layer, the spray material contains oxide ceramics and a metallic powder.

This application claims the priority of German Patent Document No. 10 2005 053 263.2, filed Nov. 8, 2005, the disclosure of which is expressly incorporated by reference herein.

### BACKGROUND AND SUMMARY OF THE INVENTION

The invention relates to a procedure for manufacturing metallic objects, such as films, sheet metal or moldings, with a photocatalytically active surface. The special feature of the photocatalytically active components (primarily titanium dioxide) consists of breaking up the compounds in the molecules of pollutants and consequently decomposing the relevant substances into non-hazardous, simply constructed reaction products.

The application of different components onto numerous substrates by thermal spraying has proven successful based on the high variability of diverse base and coating materials and its great flexibility.

It was already proposed in German Patent Document No. DE 10 2004 038 795 to manufacture photocatalytically active surfaces in composites by cold-gas spraying. In this process, particles are accelerated from the photocatalytically active oxide material by a carrier gas, they penetrate completely or partially upon impact on the polymer surface and, because of their high kinetic energy, they form a mechanically solidly adhering polymer/oxide compound. This application refers only to polymer layers. It must be remembered that the catalytic effects of the TiO₂ can also result in the decomposition of the composite.

From the citation: Formation of TiO₂ photocatalyst through cold spraying by Chang-Jiu-Li, Guan-Jun Yang, Xin-Chung Huang, Wen-Ya Xian/PRC and Akira Ohmori Osaka/J. Proceedings ITSC, May 10-12, 2004, Osaka, Japan, it is known to spray photocatalytically active powder (TiO₂) onto a metal surface using cold gas. Anatase powders of 10-45 μm are produced by agglomeration of ultra-fine particles. The primary particle size of the ultra-fine particles are 200 and 7 nanometers. These powders are sprayed onto stainless steel sheets. The problem with the cold-gas spraying of titanium dioxide is that this material cannot deform plastically. The adhesion of the particles on the metallic substrate takes place only through deformation of the metal. For this reason, a second particle impacting an already adhering particle would scarcely adhere. This problem is not addressed in the cited literature, much less solved. Pictures (scanning electron microscopic photographs of the surface) of porous TiO₂ layers are shown in which the second and additional following particle layers are most probably not bonded scratch-free to the first particle layer.

The object of the invention is to improve a corresponding method for the production of photocatalytically active layers on metal, with the aim of creating better adhering, long-term resistant layers.

### DETAILED DESCRIPTION OF THE EXEMPLARY EMBODIMENTS

This object is achieved by spraying a mixture of oxide ceramic and metallic powder instead of pure oxide ceramic. Spraying hard ceramic with a metal mixture has the advantage that components are always present which can deform upon impact. It is precisely the metal ingredients that are deformed upon impact, thus forming a new material penetrating the existing layer and thus increasing adhesion and durability.

The metal particles penetrate into the gaps, but in the same way a ceramic particle impinging on the metal penetrates into the metal and is thereby enclosed by the metal and solidly bonded with the metal.

Practically all metals and metal alloys which can be sprayed without a ceramic additive can be considered as a metal or metal components. Matched to the use of the photocatalytic layer, metals such as aluminum and copper for example, or their alloys which can be easily deformed (flexible ribbons), are of interest. Aluminum and copper are also of interest if the photocatalytically active layer is to exhibit good electrical conductivity and good heat conductivity. In an especially aggressive environment, corrosion-resistant nickel alloys or tantalum can be employed.

The size of the particles for both the metallic and the ceramic components can be in the range of 3 to 100 μm, for the metallic components it can preferably be in the range of 10 to 50 μm. When spraying using a high-pressure system, it is customary to operate with pressures of 20 to 40 bar and gas temperatures of 100 to 600° C. When spraying with what is known as portable equipment, operations are conducted at pressures up to 10 bar and a gas temperature of 300 to 60020 C.

Titanium dioxide has proved to be particularly preferable as a ceramic material. This powder occurs in various crystalline structures, wherein the photocatalytically particularly active phase anatase is metallically stable. When heated to temperatures in the range of 600 to 80020 C., this phase is converted into the thermodynamically more stable rutile phase which, however, possesses clearly lower efficiency as a photocatalyst. Such a conversion and reduction of the photocatalytic properties cannot be avoided when plasma spraying and when HVOF spraying. When cold-gas spraying in accordance with the invention, on the other hand, the photocatalytically active anatase phase is completely preserved since the temperatures of the gas used for spraying are below 600° C.

It is also possible to improve the photocatalytic properties of anatase. Current efforts are directed at shifting the photocatalytic efficiency of the material from the UV range into the range of visible light by modifying or doping the titanium dioxide. This would considerably improve the efficiency of the photocatalyst in daylight. Moreover, it has already been established that the photocatalytic efficiency of anatase is greater if this material is present in the nanocrystalline state, i.e., a powder or a layer of crystals exists whose dimensions are clearly below a micrometer, or below 100 nm. Both developments work in favor of cold-gas spraying since the warming in this process is so small that even the modified or doped condition remains intact and the extremely small crystals do not grow in the spraying process.

Instead of a mixture of two powders, an agglomerated (compacted) powder can also be used in which each particle consists of numerous small ceramic oxide and metal particles. Small particles of the size of, for example, 0.5 to 2 μm are agglomerated by the method known and practiced in the art of dry spraying into larger particles with a diameter of 3 to 100 μm so that each individual particle consists of smaller particles of both components. This happens, for example, by the small particles being given an organic binder and the suspension is then dried in a stream of hot air or gas. The binder evaporates and the smaller particles are “bonded” to each other, or joined to each other by diffusion processes.

In one embodiment of the invention, a powder can be used in place of the metal and oxide ceramic mixture in which the oxide ceramic particles are clad in a metal or metal alloy. This clad powder is then applied to the metallic or ceramic carrier materials by cold-gas spraying. In this case, the layer is polished or roughened in a second procedure by mechanical or chemical aftertreatment in order to expose the titanium dioxide still included in the cladding on the surface of the layer after spraying.

Tests have revealed that the amount of metal should be between 10% and 90%. Between 30% and 60% is preferred.

The catalytic effect of the metallic surface is given if the surface is coated in a monolayer of titanium dioxide particles. This happens even when the monolayer does not provide total coverage. Surface coverage starting at 5% is sufficient, where 5-100% shows a photocatalytic effect, where surface coverage is preferably set between 30 and 80%. Using the procedure in accordance with the invention, thicker coats can be applied in addition to monolayers which have a considerably higher load rating since the metal parts used act as adhesive means.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for manufacturing metallic objects, such as films, sheet metal or moldings, with a photocatalytically active surface through an application or introduction of a photocatalytically active material by means of cold-gas spraying technology, wherein a spray material contains an oxide ceramic and a metallic powder.

2. The method according to claim 1, wherein the oxide ceramic is titanium oxide.

3. The method according to claim 2, wherein the titanium oxide is anatase.

4. The method according to claim 1, wherein an individual oxide ceramic particle is clad with a metal or a metal alloy.

5. The method according to claim 1, wherein a volumetric amount of metal is between 10 and 90%.

6. The method according to claim 5, wherein the volumetric amount of metal is between 30 and 60%.

7. The method according to claim 1, wherein a metal surface of a metallic object is covered with a surface amount of 5 to 100% of photocatalytically active particles.

8. The method according to claim 7, wherein the metal surface of the metallic object is covered with a surface amount of 30 to 80% of photocatalytically active particles.

9. The method according to claim 1, wherein the photocatalytically active surface is subsequently processed mechanically or chemically.

10. A method for manufacturing a metallic object, comprising the steps of:
applying a photocatalytically active material to the metallic object by cold-gas spraying, wherein a spray material of the cold-gas spraying step contains an oxide ceramic particle and a metal particle.

11. The method according to claim 10, wherein the oxide ceramic particle is titanium dioxide.

12. A method for manufacturing a metallic object, comprising the steps of:
mixing a ceramic particle with a metal particle to form a mixture;
cold-gas spraying the mixture on the metallic object; and
forming a photocatalytically active layer on the metallic object by the mixture.

13. The method according to claim 12, wherein the ceramic particle is titanium dioxide.

14. The method according to claim 13, wherein the metal particle is aluminum or copper.

15. The method according to claim 12, wherein the step of forming the photocatalytically active layer on the metallic object by the mixture includes the step of deforming the metal particle.

16. The method according to claim 12, wherein the step of mixing the ceramic particle with the metal particle includes the step of bonding the ceramic particle to the metal particle.

17. The method according to claim 12, wherein the ceramic particle is included in a powder of ceramic particles and wherein the metal particle is included in a powder of metal particles.

18. The method according to claim 17, wherein the powder of metal particles is between 30% and 60% of the mixture.

19. The method according to claim 12, wherein the metal particle has a size of between 10 and 50 μm.

20. The method according to claim 19, wherein the ceramic particle has a size of between 3 and 100 μm.
